(19) United States
(12) Patent Application Publication
(10) Pub. No.: US 2003/0035178 A1
(43) Pub. Date: Feb. 20, 2003

(54) Solid-state system for tracking and regulating optical beams

(76) Inventor: George Seaver, Cataumet, MA (US)

Correspondence Address: Leslie Meyer-Leon, Esq., IP Legal Strategies Group P.C., 901 Main Street, P.O. Box 280, Osterville, MA, 02655-0280, US

(21) Appl. No.: 09/932,497

(22) Filed: Aug. 17, 2001

(51) Int. Cl. H04B 10/00

(52) U.S. Cl. 359/159; 359/172

(57) ABSTRACT

A system comprising a solid-state optical beam regulator, an optical sensing device, and a computer provides for fast, accurate, and automatic tracking, steering, and shaping of an optical beam, such as that required in free-space optical communications. With a CMOS imager as the sensing device and a regulator constructed of a stress-optic glass material whose index of refraction is altered by induced stress, the system can track beam perturbations at frequencies greater than 1 kHz. This performance makes the system suitable for a variety of applications in free-space optical communications.

### BACKGROUND OF THE INVENTION

This invention relates to the tracking and regulation of optical beams. More particularly, it relates to the tracking, steering, and shaping of laser beams in free-space optical communications (FSOC).

The tracking and steering of optical beams have been done traditionally by combinations of cameras and mirrors that are moved by electro-mechanical devices. The camera tracks an incoming reference beam or beacon, and the mirror steers the transmitted beam to make desired beam path corrections. See Jet Propulsion Laboratory, California Institute of Technology, “Acquisition, Tracking, and Pointing in Optical Communications,” JPL New Technology Report NPO-20889, and U.S. Pat. No. 5,517,016, issued May 14, 1996.

Such a system has significant shortcomings for optical communications, because cameras and steering mirrors have relatively slow response speeds (less than 70 Hz) and because such systems are unable to alter the shape of the optical beam. The slow response speeds cannot compensate for such disturbances as platform vibrations and some atmospheric disturbances, and decollimation causes the beam to diverge. These effects result in beam pointing errors and weak signals, rendering the system undesirable for long-range optical communications.

It is desirable to provide precise optical beam tracking and steering that are fast enough to respond to platform vibrations and atmospheric turbulence. It is also desirable to provide precise re-collimation of an optical beam whose collimation has been degraded. It is also desirable to have a solid-state system that is simple, rugged, and inexpensive.

### SUMMARY OF THE INVENTION

The invention relates to a system for tracking and regulating optical beams. Preferably, the system comprises three components: a solid-state optical beam regulator, an optical sensing device, and a computer that uses beam information from the optical sensing device to determine the desired controls to be implemented by the regulator.

In operation of the system, the optical sensing device produces information about the location of an incoming optical beam. For example, if the sensing device is an optical imager, the imager can scan its pixels to locate the incoming beam. There are several possible sources for this beam: it can be, for example, a reference beam from a celestial body, a beacon beam from the target receiver, or a retro-reflection of the transmitted beam. The imager sends pixel information to a computing system, such as one or more computers, and the computer calculates the received beam's position and the displacement of this position from a previously specified position of the beam in the pixel field. Alternatively, if the imager has sufficient computational capability, this function can be performed in the imager. The computer then calculates a beam steering control signal and sends that signal to the optical beam regulator, which responds by steering the beam towards the desired location. Optionally, either the beam regulator or the optical sensing device can have a control device associated with it, or both can have such devices. For example, it may be necessary to translate the digital output of the computer to an analog voltage for the regulator. Also optionally, such control devices as are necessary can be integrated with the computer or with the devices that they control.

In another embodiment, the system can also be used to shape the optical beam. In this mode, the dimensions of the beam are determined by the imager, and the deviation from the beam's desired state is calculated by the computer (or by the imager). The computer then calculates a beam shaping control signal and sends that signal to the optical beam regulator, which responds by shaping the beam to a state closer to its desired state. For example, if the purpose is to maintain the beam in a collimated state, the shaping control signals are calculated to reduce any decollimation of the beam. In practice, when the system is used both to steer and to shape the beam, the steering and shaping control signals can be combined.

In one embodiment, the optical beam regulator used can be a solid-state device capable of steering the beam, or of shaping it, or both. One example is a stress-optic regulator based on the stress-optic refractor of SeaLite Engineering, Inc. This stress-optic refractor can perform both steering and shaping functions, but a regulator that can perform only a steering function, or only a shaping one, could also be appropriate in some applications. For example, in the case of satellite-to-satellite optical communications, where there is no atmosphere between the sending and receiving locations, only the steering function is needed. In contrast, where the purpose is to calibrate the communication beam's collimation, only the shaping function is needed. Although these solid-state beam regulators have been used in a variety of other applications, their advantages in free-space optical communications have not previously been recognized. Indeed, to the extent that the use of these beam regulators in long-distance applications has been suggested, the suggestions have not involved the steering and shaping of a communication beam by such regulator, but rather the alignment of many portions of a single wavefront by multiple regulators. Among other features, the shaping of the beam by two orthogonal stress-optic cylindrical lenses and the linear superposition of the shaping signals with a stress-optic beam deflection signal into one voltage signal to the refractor at high speeds is a unique aspect of this system.

In one embodiment, the stress-optic regulator comprises a stress-optic material having an inlet window for receiving an optical beam, an outlet window for emitting a steered and/or shaped optical beam, and a means of applying a mechanical force to produce within the optical material a stress or stress gradient that changes the index of refraction of the optical material. The stress-optic material is generally a stress-optic, transparent mass, more particularly a slab or rectangular block, whose index of refraction changes with mechanical, electrical, photonic, or other stress that is applied. The transparency of the stress-optic material permits the optical beam to pass between the inlet and outlet windows, and the internal changes in the material's index of refraction alter the path and/or the shape of the beam, steering and/or shaping it.

### BRIEF DESCRIPTION OF THE DRAWINGS

FIG. 1 is a schematic view of a system for tracking and regulating an optical beam of the invention using a reflected portion of the transmitted beam as the reference.

FIG. 2 is a schematic view of a system for tracking and regulating an optical beam of the invention using a beacon beam from the receiver as the reference.

FIG. 3 is a schematic view of an optical beam regulator where both dimensions are regulated on the same substrate.

FIG. 4 is a schematic view of an optical beam regulator where two one-dimensional regulators are used in series to create two-dimensional regulation.

FIG. 5 is a schematic view of an optical beam regulator where multiple traverses of the substrate provide for amplification of the beam deflection.

FIG. 6 is a graph of contours (iso-indices) of constant index of refraction for a regulator cross section in a beam steering mode. The axes represent the proportions of the regulator's cross-sectional dimensions.

FIG. 7 is a graph of contours (iso-indices) of constant index of refraction for a regulator cross section in a cylindrical lensing mode. The axes represent the proportions of the regulator's cross-sectional dimensions.

FIG. 8 is a graph of contours (iso-indices) of constant index of refraction for a regulator cross section in a spherical lensing mode. The axes represent the proportions of the regulator's cross-sectional dimensions.

### DESCRIPTION OF THE EMBODIMENTS

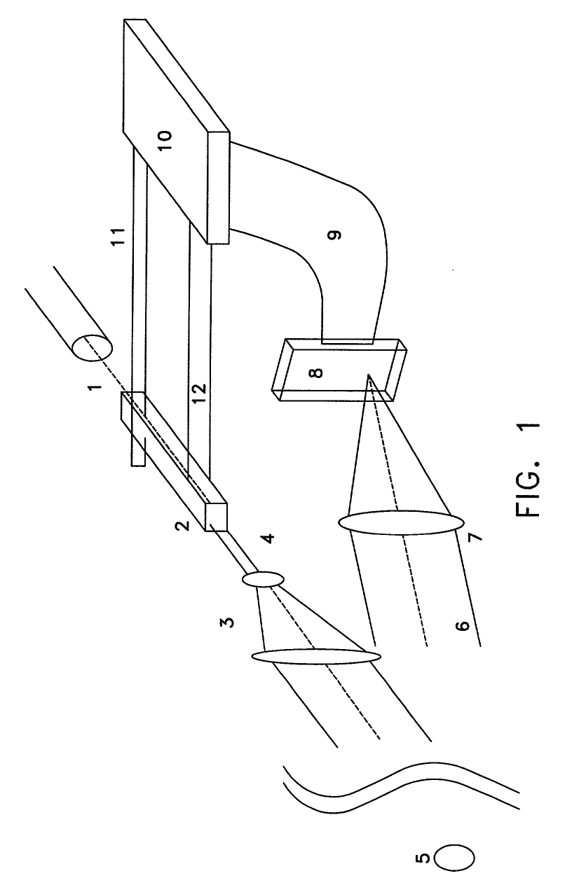

FIG. 1 shows a configuration of the invention for solid-state tracking and regulation of optical beams for short ranges, such as in access in metropolitan settings to the optical fiber trunk system. An optical beam source or sources transmits beam 1 through the optical beam regulator 2, from which it exits as a regulated (steered and/or shaped) beam 4. Regulated beam 4 then passes through beam expander 3 and into free space toward receiver 5. Receiver 5 then reflects a portion of beam 4 as beam 6, which is received and focused by lens 7 onto optical sensing device 8. Optical sensing device 8 sends the beam's position and/or shape via electrical connections 9 to computer 10. Computer 10 then sends control signal 11 to regulator 2 in order to change the horizontal deflection and shape of beam 1 and control signal 12 to change the vertical deflection and shape of beam 1, thus keeping beam 1 at a given position and with a given shape at receiver 5.

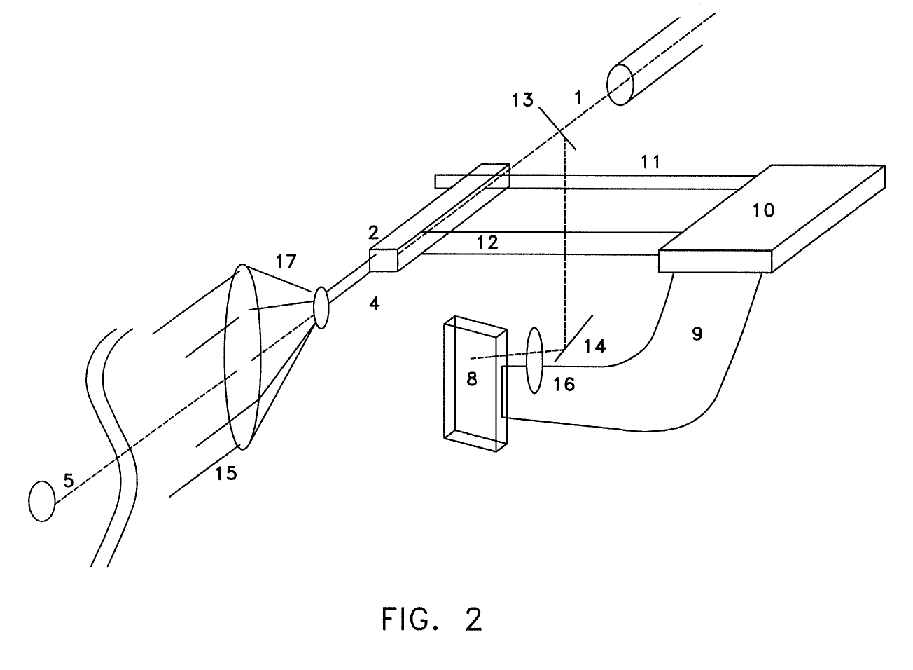

FIG. 2 shows a configuration of the invention for the solid-state tracking and regulation of optical beams for short and medium ranges, such as in metropolitan access, between ground and satellites, and between satellites in duplex, two-way communications where a beacon signal is used. An optical beam source or sources transmits beam 1 through directional mirror 13 and optical regulator 2, from which it exits as a regulated (steered and/or shaped) beam 4. Regulated beam 4 then passes through beam expander/condenser 17 and into free space toward receiver 5. Receiver 5 also transmits beacon 15, which is received by expander/condenser 17, passes through regulator 2 to directional mirror 13, and thence on to mirror 14. Lens 16 then focuses beacon 15 onto optical sensing device 8. Optical sensing device 8 sends the beacon's position and/or shape via electrical connections 9 to computer 10. Computer 10 then sends control signal 11 to regulator 2 in order to change the horizontal deflection and shape of beam 1 and control signal 12 to change the vertical deflection and shape of beam 1, thus keeping beam 1 at a given position and with a given shape at receiver 5.

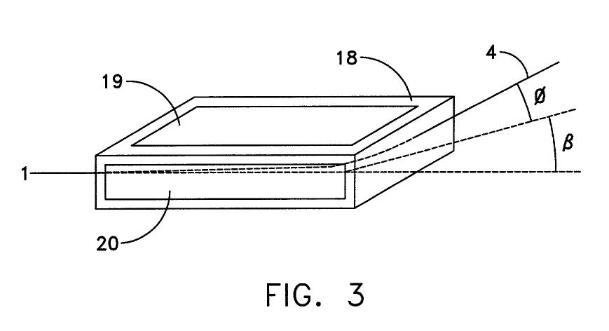

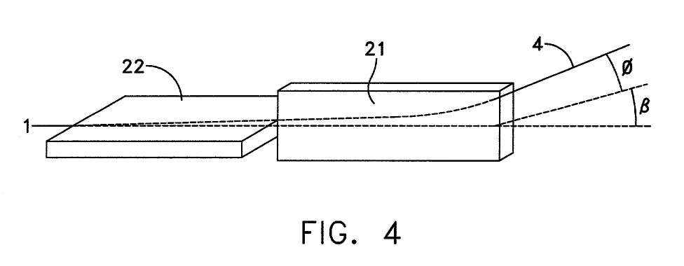

FIGS. 3 and 4 show two means of creating two-dimensional beam steering and/or shaping with beam regulators.

FIG. 3 shows an optical beam regulator 18, implemented by a stress-optic refractor that accomplishes both two-dimensional steering and shaping in a single device. Regulator 18 has piezoelectric films on all four sides. Optical beam 1 enters regulator 18 and is regulated (steered and/or shaped) vertically by the stress field created by piezoelectric films 19; as a result of the steering, the regulated beam 4 exits regulator 18 at vertical angle φ. In addition, beam 1 is steered and/or shaped horizontally by the stress field of piezoelectric films 20; as a result of the steering, regulated beam 4 exits regulator 18 at horizontal angle β. The shaping effect is not shown in the figure. Piezoelectric films 19 and 20 can be adhered to one side or to the two opposing sides of regulator 18 and are independently commanded by an applied voltage to expand or contract and thus to impose a stress gradient and resultant index of refraction gradient within regulator 18, thus independently creating vertical and/or horizontal steering and/or scanning of the beam.

FIG. 4 shows two one-dimensional beam regulators 21 and 22 that are stress-optic refractors aligned perpendicular to each other and in series to effect two-dimensional steering and shaping of an optical beam. Beam 1 transiting both scanners exits as regulated beam 4 at horizontal angle β and vertical angle φ to beam 1's entrance direction. This configuration can achieve greater beam deflection in the steering mode and greater and more precise one-dimensional cylindrical lensing using one of the regulators and greater two dimensional spherical lensing using both one dimensional regulators in series, but on perpendicular axis, in the shaping mode. This is of particular value in correcting for atmospheric beam distortions that are not spherical or symmetrical in nature. The asymmetry in beam shape can be assessed by the imager or computer and correction signals can then be fed back to the cylindrical lens capability of the regulators.

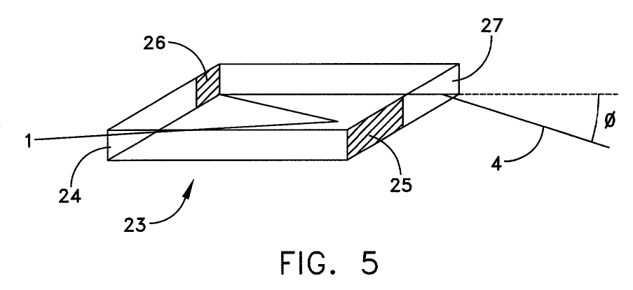

FIG. 5 shows a beam regulator that is a stress-optic refractor that greatly amplifies the optical deflection and shaping of the optical beam by providing with the use of mirrors covering portions of the inlet and outlet windows for multiple paths of the entering optical beam back and forth within the regulator before exiting. Beam 1 enters the regulator 23 through entrance window 24, then is reflected off mirror faces 25 and 26, exiting through window 27 as regulated beam 4 at angle φ to the beam 1 direction, angle φ being approximately three times larger than it would have been with but one path through the regulator.

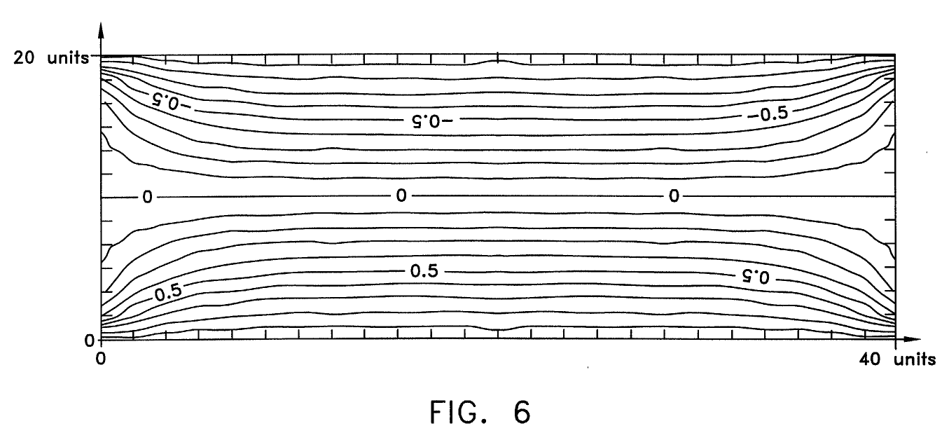

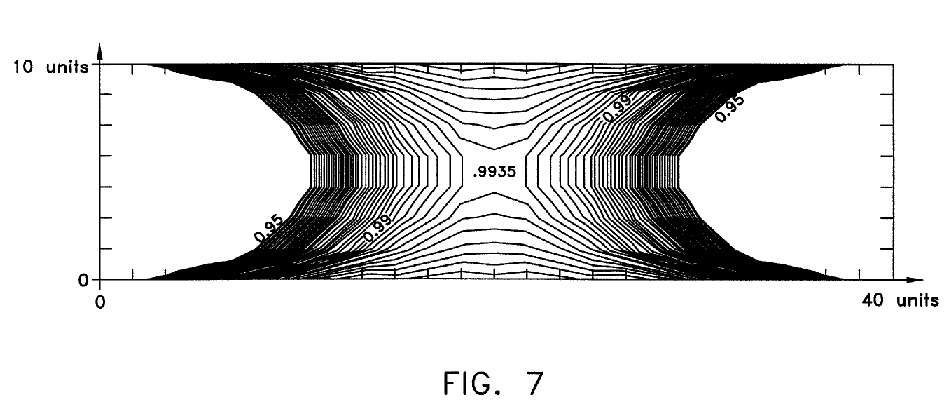

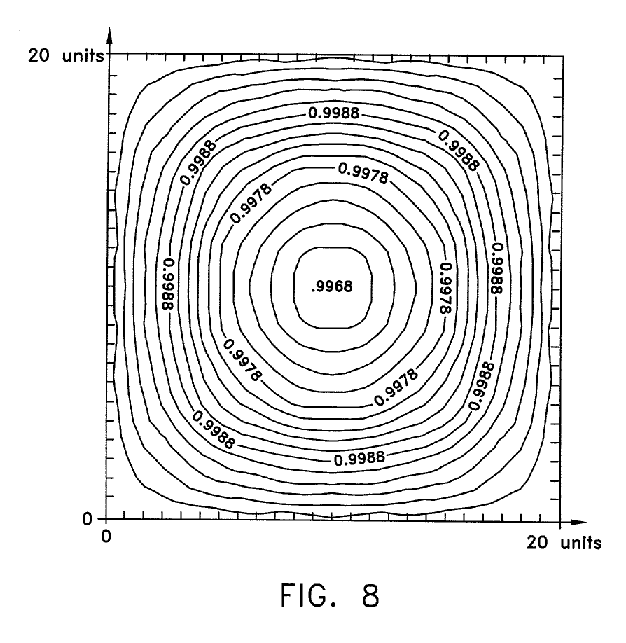

FIGS. 6, 7, and 8 show the results of finite element analyses of the index of refraction produced by stress applied to a stress-optic regulator. The graphs show contours (iso-indices) of constant index of refraction for several regulator cross sections. FIG. 6 shows the iso-indices for beam steering; FIG. 7 shows the iso-indices for cylindrical lensing; and FIG. 8 shows the iso-indices for spherical lensing. A higher positive contour represents a higher index of refraction, and beam segments are steered from lower contours to higher ones.

The optical sensing device can be any of several types of devices, including CMOS optical imagers, quadrant detectors or position sensing detectors (PSDs). One example of an imager is Photon Vision Systems's ACS-I image sensor, a CMOS imager, which is covered by U.S. Pat. No. 6,084,229, issued Jul. 4, 2000; that patent is hereby incorporated by reference. With a 90 MHz clock speed, a CMOS imager can have a frame rate of 75 frames per second for the entire image. The full frame need not always be scanned, however. After the initial determination of the location of the beam, the imager can reduce its pixel scan area in subsequent iterations to a particular region of interest, containing fewer than all the imager's pixels, based on the beam's previous position and the steering or shaping signals that were implemented. In an iterative process the number of pixels scanned is thus greatly reduced. This increases the frame rate and improves the system response time. For a 100-by-100-pixel sub-region of the frame, a CMOS imager can achieve a frame rate of 4 kHz, allowing for high frequency tracking and regulating.

The optical sensing device need not be an imaging device. An alternative optical sensing device is a quadrant detector, such as an RCA C30927E silicon photodiode. Although such a detector does not produce the information on beam shape and size that can be produced by an optical imager, its response time and sensitivity can be greater. Other optical sensing devices are also possible, with the particular choice of sensing device determined by system requirements, such as the need for beam position and/or shape information, response speeds, power consumption, size, ruggedness, weight, and cost. Another optical sensing device with characteristics appropriate for some applications is a position-sensing detector (PSD), such as the model 2L20 PSD from SiTek Corporation. This device cannot provide beam size and shape, but does provide the centroid position of the beam to great accuracy and does so at speeds greater than 15 Khz with a simple, low-cost device.

The solid-state optical regulator can also be any of several types of devices. One example of an optical beam regulator is a stress-optic refractor of SeaLite Engineering, Inc. This regulator is covered by U.S. Pat. No. 5,016,597, issued May 21, 1991; U.S. Pat. No. 5,095,515, issued Mar. 10, 1992; U.S. Pat. No. 5,383,048, issued Jan. 17, 1995; and U.S. Pat. No. 6,034,811, issued Mar. 7, 2000; these patents are hereby incorporated by reference. Another alternative for the optical regulator is an acousto-optic Bragg cell, which uses diffraction rather than refraction to steer the optical beam. A Bragg cell cannot, however, be used to shape a beam, and has other limitations such as a non-Gaussian beam shape, relatively large size and weight, significant power consumption, RF radiation, and high cost.

An example of a material that can be used for a stress-optic refractor used as the optical beam regulator is a transparent glass material such as arsenic trisulfide, zinc selenide, or other infrared material. These glasses have good transmission properties in the near infrared range, ideal for the wavelengths used in optical communications, and also have good stress-optic properties. The stress-optic coefficient is given by:

$$\begin{matrix}{K}_{∥} = {n}^{3} / E [ μ {p}_{12} - {p}_{11} / 2 ] \\ or \\ {K}_{⊥} = {n}^{3} / 2 E [ μ {p}_{11} + ( μ - 1 ) {p}_{12} ]\end{matrix} \qquad Equation ( 1 )$$

where K_{∥} is the stress-optic coefficient parallel to the applied stress; K_{⊥} is the stress-optic coefficient perpendicular to the applied stress; μ is Poisson's ratio; n is the index of refraction; p₁₂ and p₁₁ are the Pockel's coefficients for force and direction; and E is Young's modulus.

Application of stress to the stress-optic material results in changes to the material's index of refraction. Thus, when the beam passes through the material, it is refracted in a manner determined by the stress applied.

Acceptable stress-optic materials include, but are not limited to, arsenic and zinc compounds useful in the infrared range, such as arsenic trisulfide (As₃S₃), arsenic selenide (AsSe), zinc selenide (ZnSe), and zinc sulfide (ZnS). For such materials the index of refraction is approximately 1.5 times larger, the Young's modulus is approximately 3 times smaller, and the Pockel's coefficient is approximately 1.3 times larger than for those optical materials previously used for refractors in the visible spectrum. This leads to an approximately ten-fold increase in the stress-optic coefficient given in equation (1), as well as resulting in much lower losses for the wavelengths used in optical communications.

The beam deflection in a stress-optic regulator is given by:

φ≈2*L/tᵣ[K_{∥}*ΔS]; Equation (2)

where L is optical path length; tᵣ is regulator thickness; and ΔS/tᵣ is stress gradient.

Thus, a ten-fold increase in beam deflection over earlier refractor models is provided by the use of these stress-optic materials. This capability is useful in extending the range of this invention to acquire a more wayward reference beam or beacon.

A variety of techniques—electrical, photonic, mechanical, or other force techniques—can be used to apply a desired force or bending moment to a stress-optical transparent material in order to create a desired stress gradient within the material. For example, a piezoelectric (PZT) material can be secured to the stress-optic material to apply and to change continuously a selected force to create stress and selected changes in the index of refraction gradient and provide either a one-dimensional or two-dimensional optical beam regulator. For a one-dimensional regulator, two thin films of PZT of opposite piezoelectric polarity sandwich the stress-optic material, and when electrically activated, create a bending moment and stress gradient, and a consequent index-of-refraction gradient, within the regulator. For a two-dimensional regulator, two pairs of films are used, each pair on external orthogonal surfaces; either pair, when activated, creates an index-of-refraction gradient, and when both pairs are activated, two orthogonal gradients are superimposed within the regulator, allowing the beam to be regulated in two dimensions. This approach has the advantage of up to a megahertz response rate, depending upon the switch material and size. The stress and index change propagate through the optical material at the speed of sound in that material, so the response time of the material is determined by this speed and the thickness of the material.

The system can provide for either steering or shaping, or both, by the stress-optic regulator. When the piezoelectric film on one face of the regulator is expanded (or contracted) and the film on the opposite face is contracted (or expanded), a linear or approximately linear index-of-refraction gradient will be created and the beam will be steered, or deflected. When the piezoelectric films are expanded (or contracted) on both faces simultaneously, a curved gradient is created. More specifically, when the index distribution is such that the index of refraction in the outer parts of the regulator is greater than the index in the center of the regulator, the regulator functions as a diverging lens, and when the index in the outer parts of the regulator is less than the index in the center of the regulator, the regulator functions as a converging or focusing lens. With the operation of 2 opposite PZT faces in the lensing mode the beam shaping result is that of a cylindrical lens. With all 4 PZT faces used in the lensing mode, the result is that of a spherical lens. For a combination of both steering and shaping operation of the PZT films, as determined by the computer and based upon the input from the optical sensing device of beam position and shape, the effect on the beam includes both steering and shaping, so as to return the beam to its correct alignment and collimation.

The calculation of the desired deflection signal is a straightforward application of feedback theory applied to the positional error at the imager. Calculations may be performed by a computer, or by a system of one or more computers operating at proximal or at remote locations.

The nominal angular error of the beam is:

φₑ≅e/(2d*m) Equation (3)

where the positional error at the imager is e, the distance to the target is d, and m is the de-magnification caused by lens 7 in FIG. 1.

Then if the beam regulator is a stress-optic refractor with piezoelectric films, the relationship between stress and voltage is:

ΔS=E*d₃₁*V/tₚ Equation (4)

where ΔS is the stress differential, E is Young's modulus; d₃₁ is the piezoelectric coefficient, V is the applied voltage, and tₚ is the piezoelectric film thickness.

By equating the angles φ and φₑ in equations (2) and (3), the theoretical voltage output required for the regulator to bring the beam back on target can be calculated:

V=(tᵣ*tₚ/(4*d*m*L*K_{∥}*E*d₃₁))*e Equation (5)

In practice, this process of applying this calculation can be performed in a variety of ways. For example, the computer can use calibration or a look-up table to determine the theoretical voltage change required. However, because beam oscillation can occur if beam overshoot is allowed, techniques must be employed to prevent this. For example, the system can apply only 85% of the theoretical voltage and use damping techniques.

The lensing, or shape-correction, process is conceptually similar, and the lensing effects for the stress-optic refractor have been calculated using numerical Finite Element Analysis (FEA) techniques. Typical FEA results showing contours (iso-indices) of constant index of refraction for several regulator cross sections are given in FIGS. 6, 7, and 8. FIG. 6 shows the iso-indices for beam steering; FIG. 7 shows the iso-indices for cylindrical lensing; and FIG. 8 shows the iso-indices for spherical lensing. A higher positive contour represents a higher index of refraction, and beam segments are steered from lower contours to higher ones. The form of analysis shown in these figures has been confirmed through experimentation. Also through laboratory experimentation, it has been established that there is a linear superposition of the two effects, steering and lensing. And with the null feedback from the beam minus reference position from the imager/computer, this embodiment thus provides for the tracking, steering, and shaping of optical beams to compensate for beam wander and distortion caused by building motion, platform vibrations, and atmospheric index fluctuations.

An example of a regulator currently in operation will demonstrate its actual dimensions and performance. A device that is 4 mm square and 25 mm long, with piezoelectric films on all four 25 mm-long sides allows a 1.25 mm beam to be steered in two dimensions at 2 kHz rates and to a 6 milliradian scan angle. Experimentally, we find that after passing through a beam expander, the transmitted beam becomes a 12 mm beam, with a 1 milliradian scan range and a 1 microradian sensitivity or better. The beam expander both expands the beam and reduces its scan range according to the principles of optics. The sensitivity is less than 1 microradian before the expander. The beam after traveling 100 meters in our test tract is 22 mm in diameter. For greater scan ranges, two one-dimensional stress-optic deflectors can be placed in series; this provides for 10 milliradian scan ranges, sensitivities of less than 1 microradian, and beam diameters of 10 to 20 mm. There is a reciprocal relationship between the collimated beam diameter and its scan range given by the principles of optics for lens systems.

If it is desirable to increase the angle by which the optical beam is refracted, this can be accomplished by using multiple paths back and forth through the regulator as shown in FIG. 5. Each passage through the regulator subjects the beam to the same degree of refraction, so multiple back-and-forth passages amplify the steering and/or shaping effect. This can increase the angular range over which the reflected beam, the beacon, or the reference beam can be acquired by the system of this invention.

As described above, the response limit for the stress-optic regulator itself is set by the speed of sound in the regulator's glass. In the case of a 2-mm thick arsenic trisulfide regulator, the transmission time is 10 microseconds, giving a capability of deflections at 100 kHz. This system response is sufficient to allow for the compensation of high-frequency platform vibrations, acoustic vibrations, and turbulence-induced index-of-refraction fluctuations but slow enough not to effect the gigahertz rate at which the laser communicates. The beam steering and shaping change is a “frozen field” to the laser modulation changes.

The paragraphs below describe examples of embodiments of the invention. A first embodiment is free-space optical communications for point-to-point communications in a metropolitan setting. The goal is to provide communications from the optical fiber “core” network to large users at ranges from 200 to 1000 meters. A sub-category within this application is to provide communications from the fiber “core” to residential users and for temporary use at such events as sporting contests and news events. A second embodiment is free-space optical communications between a ground station and an orbiting earth satellite, or between two orbiting satellites. A third embodiment is free-space optical communications between an earth station and a deep space satellite.

The problem for metropolitan-area users of gaining access to the high bandwidth of optical communications is frequently called “the last mile bottleneck.” It is difficult and expensive to bring optical fiber to individual businesses or to local area networks in a city environment. One solution being tried in a number of cities now is free-space optical communications, where a user, either a business or a LAN, sends a laser beam through a window or from the roof of its building to a node connected to the fiber optic network. Presently, to compensate for building sway, thermal twisting, vibration, and atmospheric distortions, the divergence of the beam is made large, so that when the beam wanders a portion of it will always be “on target.” This has the obvious drawback of wasting optical energy and limiting the range of operation for a given power output, particularly under conditions of high atmospheric scatter. Conventional mechanical tracking systems have been tried by, for example, AT&T; these systems have been too slow, cumbersome, and unreliable. AT&T has stated that they require a FSOC system for wide usage in business and residential settings that has focus as well as deflection control at kHz rates, is rugged for broad commercial usage, is mass-producible, and is low in cost. The feedback control of the beam's shape and collimation in two orthogonal dimensions is a unique attribute of the system of this invention that answers the first requirement. The fast response time, simplicity, and solid-state durability meet the other requirements of the metropolitan access application.

Another application of the metropolitan access aspect of this invention comes in the mobile or portable use of free-space optical communications. The simple, compact, rugged, and lightweight nature of the components of this invention lends itself for use at such temporary settings as sporting events, civic gatherings, and news events. A further use for the unique features of this invention comes in the extension of the benefits of optical bandwidth to the residential customer market. The ordinary glass used in the optical regulator, the use of conventional piezoelectric films, and the readily mass-produced CMOS imager provides an inexpensive and affordable device for citizen purchase. Also, as the piezoelectric films that create the stress field are micro-capacitors, the power consumption of the system is that required to charge small, nanofarad capacitors times the response rate. This is in the milliwatt range per charge.

A second application of this invention is its use in optical communications between two earth-orbiting satellites or between an earth-orbiting satellite and a ground station. In satellite-to-satellite communications, spacecraft vibrations cause unacceptable mispointing errors if not compensated for. These errors are significant at frequencies of 300 Hz and greater. The currently available fast steering mirrors do not reach out to these frequencies and have moving parts which are not as rugged as solid-state devices. For satellite-to-ground communications, atmospherically induced beam wander is also a problem. The scintillation also caused by atmospheric fluctuations can be reduced by the use of multiple independent lasers as the optical source. The solid-state, high-speed stress-optic beam pointing, the CMOS tracking, and the computer analysis and feedback of the beam shape and position of the second embodiment of this invention solves the high frequency, the ruggedness and the beam wander problems. And the lightweight nature and low power consumption of the components of this invention are suited to the requirements of space applications which require low weight, small size and low power consumption. The stress-optic regulator requires a few milliwatts to charge the piezoelectric capacitor and dissipates a few microwatts during this charge. A full charge represents a maximum scan of the regulator, so the power required by the regulator is the average percentage of full deflection, which is dependent upon the amplitude of the vibration or disturbance to be corrected for, times the rate at which it happens, which is the vibration or disturbance frequency. A very strong vibration at 500 Hz would require about 0.5 watts. The CMOS imager uses about 150 milliwatts of power.

A third application of this invention is in optical communications between an earth ground station and a deep-space vehicle. The Jet Propulsion Laboratory at the California Institute of Technology, which has responsibility for NASA's applications of optical communications, has determined that spacecraft vibrations can create significant mispointing errors for the communicating laser beam. They have attempted to reduce this effect through the use of fast steering mirrors, vibration isolation, and inertial sensors. However, to achieve their statistical specification of a triple-standard-deviation mispointing error of 2 microradians, the solution must come from solid-state techniques. The solution is offered by this invention, and in particular by the high-speed steering of the laser beam by the stress-optic regulator and the tracking provided by the 4 kHz sub-frame read rate of the CMOS imager. As with the earth satellite application, the lightweight nature and low power consumption of the components of this invention add to the suitability of this invention to deep-space use. Also, the pointing accuracy to better than a microradian and the ability of the system to analyze both the position and the beam condition are suited to a deep space FSOC application. The beam analysis would be used for such tasks as determining the earth's limb contrast, the moon's shape or the size of a star's image.

The invention has been described for the purpose of illustration only in connection with certain embodiments and applications. However, it is recognized that various changes, modifications, additions, and improvements may be made to the illustrated embodiments by those skilled in the art, all falling within the spirit and scope of this invention.

The invention claimed is:

1. A system for tracking and regulating an optical beam, comprising:
a) at least one solid-state optical beam regulator;
b) an optical sensing device;
c) a computer for calculating control signals using beam information from the optical sensing device.

2. The system of claim 1 wherein at least one beam regulator operates by refraction.

3. The system of claim 1 wherein at least one beam regulator is a stress-optic refractor.

4. The system of claim 1 wherein at least one beam regulator is capable of two-dimensional steering.

5. The system of claim 1 wherein the optical sensing device uses a portion of the transmitted beam reflected from the target as the beacon for tracking, steering and shaping the transmit beam.

6. The system of claim 1 wherein at least one beam regulator acts as a lens to re-focus the beam or return the beam to a collimated state.

7. The system of claim 1 wherein the system includes two one-dimensional stress-optic refractors in series.

8. The system of claim 1 wherein the optical sensing device is a CMOS imaging device.

9. The system of claim 1 wherein the optical sensing device senses a region of interest that is less than the total frame area, so as to perform at a faster frame rate, thereby allowing the device to respond to faster beam movements.

10. The system of claim 1 wherein the optical sensing device provides beam position and shape information to the computer and thence to the regulator at speeds greater than 1 kHz and position accuracies better than 1 microradian.

11. The system of claim 1 wherein the computer receives information about the beam's position from the optical sensing device, calculates the beam's displacement from a reference position, and then sends steering signals to the beam regulator, so as to steer the beam toward the reference position.

12. The system of claim 1 wherein the computer receives information about the beam's size and shape from the optical sensing device, calculates the beam's deviation from desired collimation, and then sends shaping signals to the beam regulator, so as to shape the beam toward the desired collimation.

13. The system of claim 1 wherein the system steers the beam in two dimensions and at microradian accuracy.

14. The system of claim 1 wherein at least one beam regulator can function at frequencies greater than 1 kHz.

15. A system for tracking an optical beam and regulating an optical beam over a range of frequencies including frequencies greater than 1 kHz, comprising:
a) at least one optical beam regulator;
b) an optical sensing device; and
c) a computer for calculating steering and/or shaping signals using beam information from the optical sensing device.

16. The system of claim 15 wherein at least one beam regulator operates by refraction.

17. The system of claim 15 wherein at least one beam regulator is a stress-optic refractor.

18. The system of claim 15 wherein at least one beam regulator is capable of two-dimensional steering.

19. The system of claim 15 wherein at least one beam regulator acts as a lens to re-focus the beam or return the beam to a collimated state.

20. The system of claim 15 wherein the system includes two one-dimensional stress-optic refractors in series.

21. The system of claim 15 wherein the optical sensing device is a CMOS imaging device.

22. The system of claim 15 wherein the optical sensing device senses a region of interest that is less than the total frame area, so as to perform at a faster frame rate, thereby allowing the device to respond to faster beam movements.

23. The system of claim 15 wherein the optical sensing device provides beam position and shape information to the computer and thence to the regulator at speeds greater than 1 kHz and position accuracies better than 1 microradian.

24. The system of claim 15 wherein the computer receives information about the beam's position from the optical sensing device, calculates the beam's displacement from a reference position, and then sends steering signals to the beam regulator, so as to steer the beam toward the reference position.

25. The system of claim 15 wherein the computer receives information about the beam's size and shape from the optical sensing device, calculates the beam's deviation from desired collimation, and then sends shaping signals to the beam regulator, so as to shape the beam toward the desired collimation.

26. The system of claim 15 wherein the system steers the beam in two dimensions and at microradian accuracy so as to point the beam continuously at a distant receiver.

27. A method of optically communicating in free space for metropolitan access to optical fiber networks, comprising the steps of:
a) providing the system of claim 1; and
b) operating the system to track and regulate at least one optical beam to provide duplex optical communications between sites separated by 200 to 1000 meters.

28. A method of optically communicating in free space, comprising the steps of:
a) providing the system of claim 1; and
b) operating the system to track and regulate at least one optical beam to provide communications between two sites, at least one of which is mobile.

29. A method of optically communicating in free space, comprising the steps of:
a) providing the system of claim 1; and
b) operating the system to track and regulate at least one optical beam to provide communications between an earth-orbiting satellite and a ground station or between two earth-orbiting satellites.

30. A method of optically communicating in free space, comprising the steps of:
a) providing the system of claim 1; and
b) operating the system to track and regulate at least one optical beam to provide communications between satellites in deep space wherein the reference beam may be a beacon from earth or a known planet or star.
